(19) United States
(12) Patent Application Publication
(10) Pub. No.: US 2024/0070845 A1
(43) Pub. Date: Feb. 29, 2024

(54) Damage Detection Based On Damage-Index Data

(71) Applicant: Spark Insights, Inc., Boston, AA (US)

(72) Inventors: Ira Scharf, Newton, MA (US); Xiang Wen, Westwood, MA (US); Paul Cummer, Cambridge, MA (US); Feng Pan, Belmont, MA (US); Vidyavathy Renganathan, Albany, NY (US)

(73) Assignee: Spark Insights, Inc., Boston, MA (US)

(21) Appl. No.: 18/039,624

(22) PCT Filed: Dec. 2, 2021
(86) PCT No.: PCT/US2021/061526

§ 371 Date: May 31, 2023

Related U.S. Application Data
(60) Provisional application No. 63/120,486, filed on Dec. 2, 2020.

(51) Int. Cl. G06T 7/00; G06T 5/20; G06T 7/11; G06V 10/25; G06V 10/56; G06V 20/10

(52) U.S. Cl. CPC G06T 7/0008; G06T 5/20; G06T 7/11; G06V 10/25; G06V 10/56; G06V 20/176; G06T 2207/10024; G06V 2201/07

(57) ABSTRACT

Disclosed are devices, systems, apparatus, methods, products, and other implementations, including a method for detecting damage in a geographical area that includes receiving image data for the geographical area, the image data containing data representative of one or more objects, obtaining damage-index data comprising information indicating potential damage affecting the geographical area, and detecting damage to an object, from the one or more objects in the geographical area, based on the received image data for the geographical area and the damage-index data comprising the information indicating the potential damage affecting the geographical area.

### CROSS REFERENCE TO RELATED APPLICATIONS

This application claims the benefit of U.S. Provisional Application No. 63/120,486, filed Dec. 2, 2020, the contents of which are hereby incorporated by reference.

### BACKGROUND

Natural disaster events, such as fires, flooding, earthquakes, etc., can cause substantial structural damage to large swaths of geographical areas. To assess the economic damage resulting from the occurrence of such natural disasters, image data of the of the geographic areas can be processed and analyzed to detect and/or assess the extent of resultant damage. However, the level of detail in available from the image data varies according to the equipment that may have been used to capture the photos, the altitude at which the photos were taken, and a host of other factors that complicate the accuracy of damage assessment. The inaccuracy resulting from analysis of image data is manifested, for example, as incorrect determination of damage (e.g., determining that a particular structure is damaged, when the structure, in fact has not been damaged).

### SUMMARY

Disclosed are systems, methods, and other implementations to improve detection and estimation of damage suffered by objects (e.g. physical structures, such as buildings) using supplemental data, also referred to as damage-index data, which represents information about types of damage, and its distribution (or clustering) in the geographical area for which image data has been acquired. For example, the damage index data represents regions in which water or fire damage has occurred or may possibly occur. Such information about the possible presence or distribution of certain types of damage within a geographical area, can be used to determine possible damage to property (e.g., structures) appearing in the image data obtained for the geographical area (e.g., by identifying the regions where possible damage type is present, and determining structures, or other types of objects, that are located within those regions where certain types of damage have occurred or may occur.

The damage index data can be derived directly from image data of the geographical data (e.g., by applying a detection model to the image data, to detect regions within the geographical area for which data, indicative of one or more types of damage, is available). Another example of deriving damage index data representative of one or more types of damage is by acquiring a multi-band geospatial image of the geographical area, which includes visible range data (resulting in image data similar to data acquired through regular photographic equipment), and also includes contemporaneous captured electromagnetic data for the geographical area in other bands (e.g., infrared bands). The availability of such multi-band geospatial data is used to independently derive damage index data indicative of regions in the geographical areas in which one or more types of damage data are likely present, thus providing information about what objects (homes or structures) are within those areas identified as possibly affected by one or more types of damage. For example, the determination of what regions within the geographical area are covered with water can be based on near infrared data capture.

In some embodiments, the supplemental damage-index data can also be used to adjust/modulate damage detection systems that are based (or that incorporate) statistical models for damage detection (e.g., realized using machine learning systems that implement, for example, deep neural network classifiers). In such embodiments, and as will be discussed in greater detail below, overall performance accuracy of the statistical model is optimized according to the damage-index data representative of data distribution of certain types of damage within the geographical area. This can be done by dynamically tuning an operation point for a classifier's receiver operation curve (also referred to as a precision-recall curve), which controls the classifier's precision and detection sensitivity (or recall) parameters in a Bayesian framework according to the damage-index data.

Another example of supplemental data that may be used to adjust, modulate, or otherwise influence damage detection model that incorporate historical information (also referred to as prior-knowledge information or supplemental information). Examples of historical information that can be used to control the sensitivity levels of regions (clusters) of the image data on which the detection processing is applied include historical flood data, historical wind speed data at various regions in the geographical area, recent data representative of fire paths in the geographical area, weather maps (historical and contemporaneous), etc. Prior-knowledge data can also be used to more generally adjust learning models of detection systems to help control classification decisions by, for example, assessing the extent of overlap of suspected damaged objects (within image data for a geographical area) with areas known to be affected by damage-causing events.

Thus, in some variations, a method for detecting damage in a geographical area is provided that includes receiving image data for the geographical area, the image data containing data representative of one or more objects, obtaining damage-index data comprising information indicating potential damage affecting the geographical area, and detecting damage to an object, from the one or more objects in the geographical area, based on the received image data for the geographical area and the damage-index data comprising the information indicating the potential damage affecting the geographical area.

Embodiments of the method may include at least some of the features described in the present disclosure, including one or more of the following features.

Detecting damage to the object based on the received image data for the geographical area and the damage-index data may include generating one or more damage index images (also referred to as “damage-index maps”) from the obtained damage index data, and detecting damage to the object based on the received image data and the one or more damage index images.

The image data for the geographical area may include multi-band geospatial data, and obtaining the damage-index data may include filtering the image data comprising the multi-band geospatial data to extract band data, for the geographical area, to identify one or more types of damage. Generating the one or more damage-index images may include generating, based on the extracted band data, the one or more damage index images identifying portions within each of the one or more damage-index images that potentially are affected by the respective one or more types of damage.

Filtering the image data comprising the multi-band geospatial data may include filtering the image data to extract one or more of, for example, RGB band data for the image, false color composite data for the image (e.g., NIR+R+G), or RGB band data for the image plus infrared band data for the image.

The method may further include determining regions in the geographical area associated with data representative of presence of water, including generating a normalized difference water-index (NDWI) image, corresponding to the image data for the geographical area, by computing each pixel of the water index image according to

$$N D W I = ( \frac{{x}_{green} - {x}_{NIR}}{{x}_{green} + {x}_{NIR}} )$$

with x_{green} being a green component value of a pixel of the NDWI image, and x_{NIR} being a near infrared value of the pixel.

The method may further include determining regions in the geographical area associated with data representative of potential fire damage with respect to vegetation content, including generating a normalized difference vegetation index (NDVI), corresponding to the image data of the geographical area, by computing each pixel of the fire index image according to

$$N D V I = ( \frac{{x}_{NIR} - {x}_{r e d}}{{x}_{NIR} + {x}_{r e d}} )$$

with x_{NIR} being a near infrared component value of a pixel of the image, and x_{red} being a red component value of a pixel of the image.

The method may further include determining regions in the geographical area associated with data representative of potential fire damage, including generating a normalized burn ratio (NBR) image, corresponding to the image data of the geographical area, by computing each pixel of the fire index image according to

$$N B R = ( \frac{{x}_{NIR} - {x}_{SWIR}}{{x}_{NIR} + {x}_{SWIR}} )$$

with x_{NIR} being a near infrared component value of a pixel of the NBR image, and x_{SWIR} being a short-wave infrared value of the pixel.

Generating the one or more damage index images may include applying a damage detection model, implemented on a learning machine, to the received image data for the geographical area to detect regions in the received image data associated with respective one or more types of damage-causing events.

Detecting damage to the object based on the one or more damage index images may include detecting at least some of the one or more objects in the received image data, and determining overlap between the detected at least some of the one or more objects in the received image data and regions of the one or more generated damage-index images comprising data representative of respective types of damage.

Detecting damage to the object may include dividing the image data into multiple portions according to the damage index data, and for each of the multiple portions of the divided image data, applying a damage detection model with an adjustable detection sensitivity level, including controlling the adjustable detection sensitivity level based on a portion of the damage-index data corresponding to the respective portions of the divided image data.

The adjustable sensitivity level may be controlled according to a receiver operation curve (ROC) representation. Applying the damage detection model may include dynamically tuning an operation point for the ROC for a particular portion of the image data based on likelihood of occurrence of damage, determined based on the damage-index data, in a region within the geographical area to adjust a false-positive detection rate of the detection model or to adjust a detection sensitivity value for the detection model within the region.

Dynamically tuning the operation point for the ROC may include one of, for example, decreasing the detection sensitivity value for the detection model to cause a decrease in the false-positive detection rate within the region and/or increasing the detection sensitivity for the detection model to cause an increase in the false-positive detection rate within the region.

Applying the detection model may include adjusting the detection sensitivity levels for a first region and for a second region in the geographical area so that a likelihood of identifying a first object in the first region as being damaged is higher than a likelihood of identifying a second object in the second region as being damaged, when the damage-index data indicates that a likelihood of occurrence of damage in the first region is higher than a likelihood of occurrence of the damage in the second region.

Applying the detection model may include applying a detection model implemented as a binary classifier.

Controlling the adjustable detection sensitivity level may include adjusting a discrimination threshold of the binary classifier. Controlling the adjustable detection sensitivity level may include increasing the sensitivity level for a particular region in response to determining that the portion of damage-index data for the particular region indicates higher than normal likelihood of occurrence of a damage-causing event.

The image data of the geographical area may include multi-band geospatial data, and obtaining the damage-index data may include filtering the image data comprising the multi-band geospatial data to extract band data, for the geographical area, to identify one or more types of damage, and generating based on the extracted band data one or more resultant damage index images identifying portions within each of the one or more resultant damage index images that potentially are affected by the respective one or more types of damage.

Obtaining the damage-index data may include applying a damage detection model, implemented on a learning machine, to the received image data for the geographical area to detect regions in the received image data associated with respective one or more types of damage, and generating, based on the detected regions in the received image data associated with the respective one or more types of damage-causing events, one or more resultant damage index images identifying portions within each of the one or more resultant damage index images that potentially are affected by the respective one or more types of damage.

Obtaining the damage-index data may include performing one or more of, for example, i) receiving prior-knowledge data that include one or more of historical wind speed information in the geographical area, historical flood information, historical storm path information for the geographical area, historical flood map information for the geographical area, burn-index information, vegetation index, and/or weather reports for the geographical area, ii) applying a damage detection model, implemented on a learning machine, to the received image data for the geographical area to generate segmented data representative of one or more segmented regions in the received image data associated with respective one or more types of damage-causing events, and/or iii) receiving multi-band geospatial data, and filtering the multi-band geospatial data to extract band data, for the geographical area, to generate one or more multi-band indices. Detecting damage to the object may include generating a composite damage index map based on one or more of, for example, the prior-knowledge data, the generated segmented data, and the one or more multi-band indices.

Detecting damage to the object, from the one or more objects in the geographical area, may include detecting the one or more objects in the geographical area (e.g., using filtering-based techniques to detect or identify objects, or learning engines implementing object detection models) based on one or more of, for example, currently received image data obtained subsequent to occurrence of a damage-causing event affecting the geographical area, and/or earlier received image data obtained prior to the occurrence of the damage-causing event affecting the geographical area with the earlier received image data being aligned to the currently received image data.

In some variations, a system is provided that includes a communication interface to receive image data for a geographical area, with the image data containing data representative of one or more objects, and a controller coupled to the communication interface. The controller is configured to obtain damage index-data comprising information indicating potential damage affecting the geographical area, and detect damage to an object, from the one or more objects in the geographical area, based on the received image data for the geographical area and the damage-index data comprising the information indicating the potential damage affecting the geographical area.

In some variations, a non-transitory computer readable media is provided, to store a set of instructions executable on at least one programmable device, to receive image data for the geographical area, the image data containing data representative of one or more objects, obtain damage-index data comprising information indicating potential damage affecting the geographical area, and detect damage to an object, from the one or more objects in the geographical area, based on the received image data for the geographical area and the damage-index data comprising the information indicating the potential damage affecting the geographical area.

Embodiments of the system and the non-transitory computer readable media may include at least some of the features described in the present disclosure, including any one or more of the features described above in relation to the method.

In some variations, another method for detecting damage in a geographical area is provided. The method includes receiving image data for the geographical area, the image data containing data representative of one or more objects, obtaining damage-index data comprising information indicating potential damage affecting the geographical area, dividing the damage-index data into a plurality of clusters, each associated with one or more damage probability values representative of a probability of occurrence of damage within the respective each of the plurality of clusters, and applying a detection model with an adjustable detection sensitivity level to portions of the image data associated with the plurality of clusters to detect damage to the one or more objects, wherein applying the detection model includes controlling the adjustable detection sensitivity level used for each of the portions of the image data according to the one or more damage probability values.

Embodiments of the other method may include at least some of the features described in the present disclosure, including one or more of the following features.

Obtaining the damage-index data may include receiving one or more of, for example, historical wind speed information in the geographical area, historical flood information, historical storm path information for the geographical area, historical flood map information for the geographical area, burn-index information, vegetation index, and/or weather reports for the geographical area.

The image data of the geographical area may include multi-band geospatial data. Obtaining the damage-index data may include filtering the multi-band geo spatial data to extract band data, for the geographical area, to identify one or more types of damage affecting the geographical area, and deriving based on the extracted band data one or more resultant damage index images identifying portions within each of the one or more resultant damage index images that potentially are affected by the respective one or more types of damage.

The adjustable detection sensitivity level may be controlled according to a receiver operation curve (ROC) representation. Applying the damage detection model may include dynamically tuning an operation point for the ROC for a particular portion of the image data based on likelihood of occurrence of damage, determined based on the damage-index data, in a region within the geographical area, to adjust a false-positive detection rate.

Dynamically tuning the operation point for the ROC may include one of decreasing the detection sensitivity value for the detection model to cause a decrease in the false-positive detection rate within the region, or increasing the detection sensitivity for the detection model to cause an increase in the false-positive detection rate within the region.

Applying the detection model may include adjusting detection sensitivity levels for a first region and for a second region in the geographical area so that a likelihood of identifying a first object in the first region as being damaged is higher than a likelihood of identifying a second object in the second region as being damaged, when the damage-index data indicates that a likelihood of occurrence of damage-causing event in the first region is higher than a likelihood of occurrence of the damage-causing event in the second region.

Applying the detection model may include applying a detection model implemented as a binary classifier.

Controlling the adjustable detection sensitivity level may include increasing the sensitivity level for a particular region in response to determining that the portion of damage-index data for the particular region indicates higher than normal likelihood of occurrence of a damage-causing event.

Dividing the damage-index data into the plurality of clusters may include performing a k-mean clustering process on the damage-index data to determine clusters comprising data elements satisfying an optimization criterion.

In some variations, another a system is provided that includes a communication interface to receive image data for a geographical area, the image data containing data representative of one or more objects, and a controller coupled to the communication interface. The controller is configured to obtain damage-index data comprising information indicating potential damage affecting the geographical area, divide the damage-index data into a plurality of clusters, each associated with one or more damage probability values representative of a probability of occurrence of damage within the respective each of the plurality of clusters, apply a detection model with an adjustable detection sensitivity level to portions of the image data associated with the plurality of clusters to detect damage to the one or more objects. The controller configured to apply the detection model is configured to control the adjustable detection sensitivity level used for each of the portions of the image data according to the one or more damage probability values.

In some variations, a non-transitory computer readable media is provided, to store a set of instructions executable on at least one programmable device, to receive image data for a geographical area, the image data containing data representative of one or more objects, obtain damage-index data comprising information indicating potential damage affecting the geographical area, divide the damage-index data into a plurality of clusters, each associated with one or more damage probability values representative of a probability of occurrence of damage within the respective each of the plurality of clusters, and apply a detection model with an adjustable detection sensitivity level to portions of the image data associated with the plurality of clusters to detect damage to the one or more objects. The instruction set to apply the detection model includes one or more instructions to control the adjustable detection sensitivity level used for each of the portions of the image data according to the one or more damage probability values.

In some variations, a further method for detecting damage in a geographical area is provided that includes receiving image data for the geographical area, the image data containing data representative of one or more objects, and obtaining damage-index data comprising information indicating potential damage affecting the geographical area. Obtaining the damage-index data includes performing one or more of, for example, i) receiving prior-knowledge data including one or more of historical wind speed information in the geographical area, historical flood information, historical storm path information for the geographical area, historical flood map information for the geographical area, burn-index information, vegetation index, and/or weather reports for the geographical area, ii) applying a damage detection model, implemented on a learning machine, to the received image data for the geographical area to generate segmented data representative of one or more segmented regions in the received image data associated with respective one or more types of damage-causing events, and/or iii) receiving multi-band geospatial data, and filtering the multi-band geospatial data to extract band data, for the geographical area, to generate one or more multi-band indices. The further method also includes detecting damage to an object, from the one or more objects in the geographical area, based on the received image data for the geographical area and the damage-index data comprising the information indicating the potential damage affecting the geographical area, including generating a composite damage index map based on one or more of, for example, the prior-knowledge data, the generated segmented data, and/or the one or more multi-band indices.

Embodiments of the other system, the other non-transitory computer readable media, and the further method may include at least some of the features described in the present disclosure, including any one or more of the features described above in relation to any of the above methods, the above system, or the above computer readable media.

Advantages of the embodiments described herein include improvement in the accuracy of a detection model (i.e., a learning engine implementing damage detection based on image data) based on use of supplemental data (separately and independently obtained or derived) to determine if structures/objects (such as houses) appearing in the image data are located within regions that, according, to the supplemental data, have been impacted by some damage-causing event. That supplemental data can, for example, allow fine tuning of the sensitivity of damage detection models implemented on learning machines (e.g., through adjustment of ROC curves associated within different regions for the geographical area covered by the obtained image data). Alternatively, the supplemental data can be used to identify areas of overlap between regions determined from the damage-index data to be affected by a damage-causing event, and locations of objects/structures identifiable from image data.

Other features and advantages of the invention are apparent from the following description, and from the claims.

### BRIEF DESCRIPTION OF THE DRAWINGS

These and other aspects will now be described in detail with reference to the following drawings.

FIG. 1 is a diagram of an example system to detect damage in a geographical area.

FIG. 2 is an example illustration of electromagnetic bands for which geospatial data is acquired.

FIG. 3 is a block diagram of an example damage detection implementation.

FIG. 4 shows an input image to a damage detector and a resultant output image with semantic segmentation output.

FIG. 5 includes an example illustration of the use of normalized burn ratio (NBR) data to identify regions within a geographical area that may have suffered fire damage.

FIG. 6 illustrates an example illustration of the use of normalized difference water index (NDWI) data to identify regions within a geographical area that may have suffered water damage.

FIG. 7 is an example graph with a receiver operation curve (ROC) to control damage sensitivity for detecting damage in different regions in an image of a geographical area.

FIG. 8 is a block diagram of an example damage detection system using historical information.

FIG. 9 is an illustration of the use of a sensitivity-adjustable damaged detection (prediction) model.

FIG. 10 is a flowchart of an example procedure for detecting damage in a geographical area.

FIG. 11 is a flowchart of an example procedure to detect damage using adjustable sensitivity levels to control a damage detection model.

Like reference symbols in the various drawings indicate like elements.

### DESCRIPTION

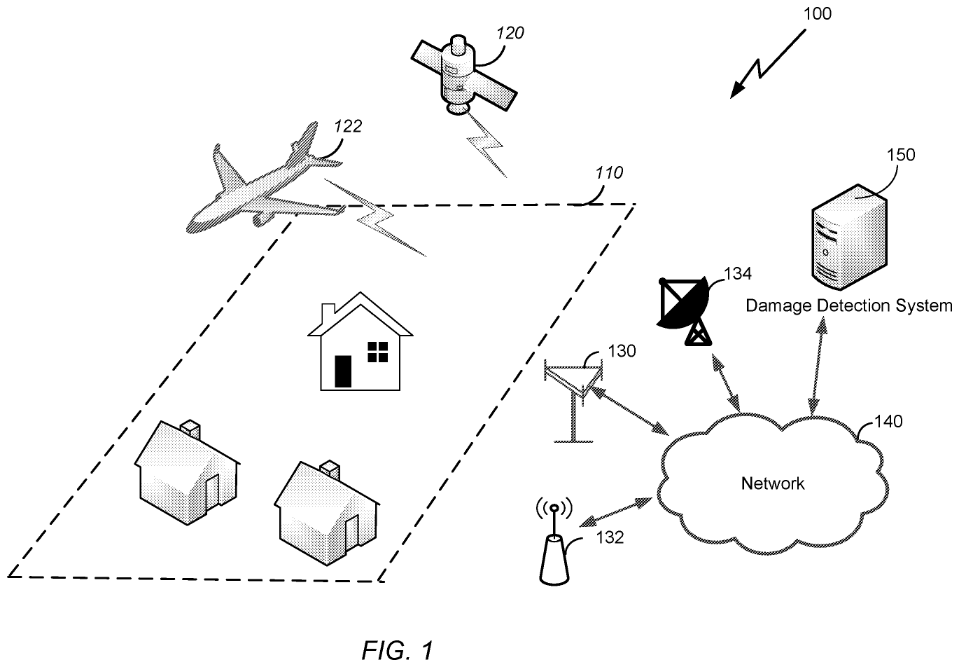

FIG. 1 is a diagram of an example system 100 to detect damage in a geographical area 110 using supplemental data, that in the examples described herein includes damage index data representative of distribution of certain types of damage within the geographical area for which an overhead image is captured. The damage-index data, typically derived independently from the process that analyzes the image data to detect potential damage to one or more objects appearing in the captured image, can thus facilitate the detection analysis by, for example, appropriately adjusting the confidence associated with damage detection output produced by the detection system. For example, the detection model can determine or predict occurrence of potential damage to an object with a higher degree of confidence when independently derived information indicates occurrence of a damage-causing event in a region containing that object.

As shown in FIG. 1, the system 100 includes one or more platforms, such as a satellite vehicle 120, and an aerial vehicle 122, which in the example of FIG. 1 is an airplane. Other types of vehicles (e.g., balloons, unmanned autonomous vehicles (UAV) such as a multi-rotor aircraft) may also be used. Generally, each of the aerial platforms is equipped with image-capture devices (not shown), that may be configured to capture and record signals inside, and optionally outside, the visible range (e.g., in the infrared range, near infrared range, short wave infrared range, and other bands on the electromagnetic spectrum). Examples of image-capture devices (e.g., to capture light in the visible range) include a charge-coupled device (CCD)-based capture unit, a CMOS-based image sensor, etc., which may produce still or moving images. An image capture device may also include optical components (e.g., lenses, polarizers, etc.) to optically filter/process captured light data reflected from the physical object, before the optically filtered data is captured by the capture unit of the image capture device.

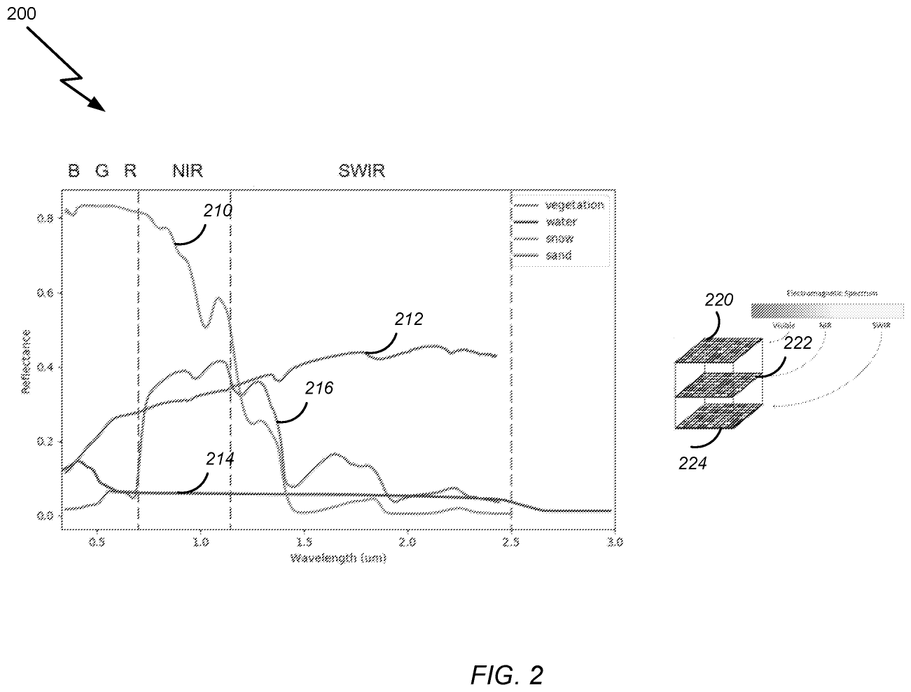

As noted, in some situations, the platforms 120 and/or 122 may be equipped with sensors to capture reflected electromagnetic radiation in additional bands outside the visible range. FIG. 2 is an example illustration 200 of multiband electromagnetic components for geospatial data acquired at a particular time instance for some geographical area. The geospatial multiband data includes energy components at various bands, including the visible range band, and various infrared bands, including the near infrared band (NIR), short-wave infrared (SWIR) band, and thermal infrared (TIR) band. The energy levels captured for the scene by sensor device(s) that are attuned to each of the different bands is affected by the nature and composition of the surfaces and materials that reflect the radiation at the different bands. Thus, different surfaces will result in different captured electromagnetic profiles that can then be used to determine the nature of the surfaces and materials that resulted in the multiband profiles being sensed. Consequently, and as will be discussed below in greater details, in embodiments in which sensors to capture electromagnetic reflections at different bands are available, geospatial surface characteristics of the scene can be determined on the basis of information from different bands. For example, the presence of water in the scene, which could be indicative of water damage if the water is found at regions that are also occupied by structures, can be determined according to a combination of the near infrared energy levels at particular locations in the scene, and one or more of the visible range components for those same locations. In some embodiments, a water damage index for each location (e.g., pixel) in the scene can be computed according to the formulation (x_{green}−x_{NIR})/(x_{green}−x_{NIR}), where x_{green} and x_{NIR} are the green component value and near infrared value, respectively, at a particular location, x. The presence of certain surfaces or materials can therefore be independently determined based on the profiles captured at various bands, and can thus provide to a more accurate detection of potential damage.

The platforms 120 and 122 may also be equipped with navigation sensors to measure information such as camera position data for the acquiring camera (e.g., expressed as geo-referencing data), camera attitude data (including roll, pitch, and heading), etc. The camera attitude data can be used, in some implementations, to normalize the corresponding image data to produce, for example, nadir view normalized images, providing a top-view of the scene, that eliminates or reduces any perspective/angle views in the image. Based on the navigation sensor measurements, geometry correction for acquired image data can be performed to rotate, or otherwise manipulate the image's pixels according to formulations that can be derived based on the navigation sensor data For example, the relative perspective of each of camera can be used to derive a transformation that is applied to the image data to yield a resultant image corresponding to a top-view of the scene.

Once the sensors mounted on platform acquire geospatial data for the scene covered by the platforms, the captured data (whether only visible-range data or multiband data) may then be written to a memory/storage device in communication with the capture unit, and/or may be transmitted to ground station communication nodes, which in FIG. 1 are depicted as a WWAN base station 130, an WLAN access point 132 (either of the nodes 130 and 132 may be configured to establish communication links to low flying aerial vehicle 122), and a satellite communication node 134 configured to transmit and/or receive signals to and from satellite vehicle 120. In some embodiments, the image-capture device may be locally coupled to processing/computing devices that are configured to implement initial processing on captured image data, such as, for example, perform calibration operations, compress or arrange raw image/video data (provided to it by the capture unit) into a suitable digital format such as a Tagged Image file (TIF) formatted images, JPEG images, or any other type of still image format, or into a digital video format (such as MPEG).

The platforms (e.g., one or both of the platforms 120 or 122) obtain sensor data in one or more electromagnetic bands associated with the geographical area 110, and transmit the acquired sensor data (suitably encoded and formatted) to ground station communication nodes (e.g., one or more of the nodes 130, 132, or 134). From there, the sensor data is communicated to the damage detection system 150 via a network 140 (which may be a packet-based network, such as the public Internet), or via wireless transceivers (not shown) included with the damage detection system 150. In addition to the sensor data transmitted to the damage detection system 150, the platform acquiring the data may also transmit positioning information, which may include their sensor-capture device's relative positions, and/or absolute positions (in a real-world coordinate system provided, for example, as accompanying geo-reference data). The transmissions to the damage detection system 150 may also include timing information.

Upon receiving the sensor data (e.g., a set of visible range image data, along, in some embodiments, geospatial data in other EM bands), the damage detection system 150 detects damage to at least one object appearing in the image constructed from the sensor data (typically, the constructed image would include data representative of visible range captured data). The system 150's includes a processing engine to generate damage-index data (supplemental data) that includes information indicating potential damage affecting the geographical area, and a detection engine (e.g., implemented as a learning machine to detect damage, or as a filtering process applied to the input image) that detects damage to one or more objects appearing in the image data based on the input image data and the damage-index data. As will become apparent below, the damage-index data may be derived from the primary image data (i.e., the same data that is processed to detect damage) by, for example, using a different learning engine (implementing a model for producing the damage-index data). Alternatively or additionally, the damage-index data may be generated based on processing applied to multiple sets of geospatial sensor data (for the particular geographical area) in different EM bands. The derived damage-index image data represents regions in the particular geographical area that are affected by one or more types of damage (e.g., regions in the area that are covered with water, or regions of low levels of vegetations, indicating that those areas may have suffered fire damage). Thus, portions of the damage-index data that correspond (overlap) regions of the primary image data that include identifiable structures can be used to determine whether those structures may have suffered damage.

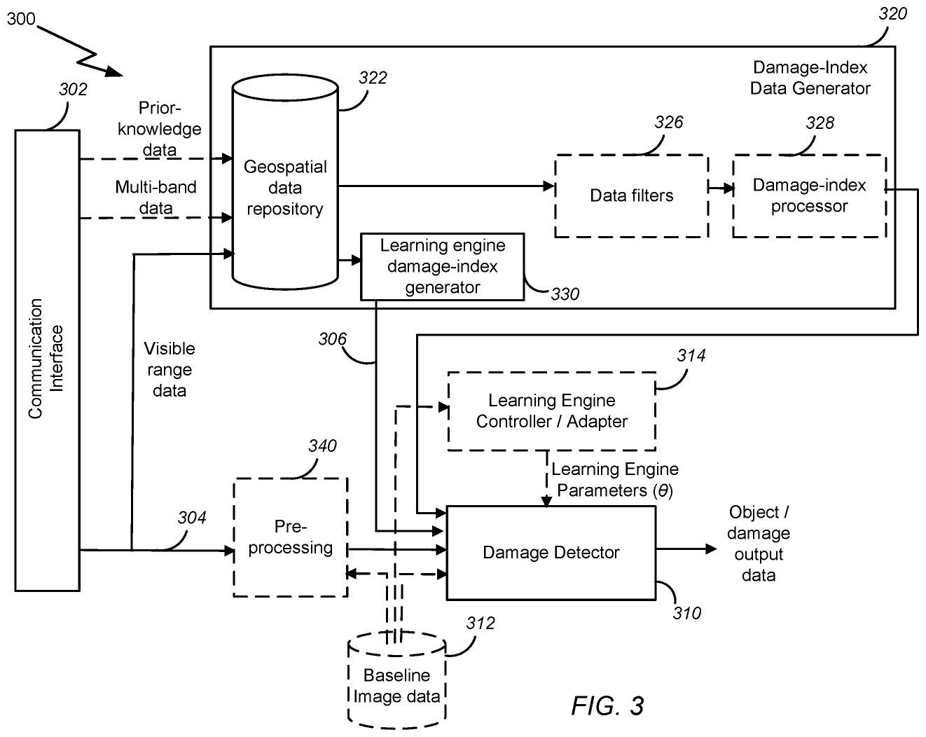

More particularly, and with reference to FIG. 3, a block diagram of an example damage detection system 300, which may be similar to the system 150 of FIG. 1, is shown. The system 300 includes a damage detector 310 (which may be implemented using a learning engine, for example, one realized using neural networks or other types of learning machines, or may be implemented as an image processing/filtering engine or as a rule-based engine) to identify objects in an image, and/or to detect damage to one or more of such identified objects (and/or determine damage estimate). The damage detector 310 receives, via a communication interface 302, as input the primary image data 304 (e.g., visible range data acquired using a light-capture device mounted on one of the overhead platforms of FIG. 1) and damage-index data 306 produced by the damage-index data generator 320. The detector 310 then produces output consistent with a match or overlap between portions of the damage index data that represent regions in the geographical area likely to have been impacted by one or more types of damage, and structures in the primary image data that are located within those areas indicated to likely to have been affected by the types of damage represented by the one or more damage-index data sets.

In embodiments in which the damage detector 310 is implemented based on a learning engine, the system 300 further includes a learning engine controller/adapter 314 configured to determine and/or adapt the parameters (e.g., neural network weights) of a learning engine-based detector that would produce output representative of detected objects and/or detected damage appearing in the primary image data, based on supplemental damage index data (304 or 306) provided from the damage-index data generator 320. To train the damage detector 310, a training data set is generally used that includes primary image data and supplemental training damage-index data. Such data may be associated with the specific geographic area 110 of FIG. 1 that is to be monitored when the detection system 300 becomes operational (i.e., during runtime), or may be associated with different geographical areas so that the detector 310 is adapted to produce reliable output data in response to input data (primary and supplemental) from any geographic area. Generally, the more specific the training is, the higher the accuracy and confidence level associated with the output generated by the damage detector 310. After a learning-engine based implementation of the damage detector 310 has become operational (following the training stage) and can process actual runtime data, subsequent run-time training may be intermittently performed (at regular or irregular periods) to dynamically adapt the detector 310 to new, more recent training data samples in order to maintain or even improve the performance of the detector 310.

Alternatively or additionally, the detector 310 may be implemented based on the application of image processing filtering, e.g., to detect shapes and objects in the image through, for example, edge detection filtering, morphological filtering, etc. Such processing may be facilitated by an optional pre-processing module 340 depicted in FIG. 3

As noted, determination of the existence of possible damage to structures appearing in the primary image data (e.g., data acquired from sensors tuned to the visible range band) is informed by supplemental data that provides an independent source of information about the presence of a damage-causing factors, such as the presence of water in the geographical area, the occurrence of fire in the geographical area, etc. to that end, the damage-index data generator 320 produces that separate, independent source of information.

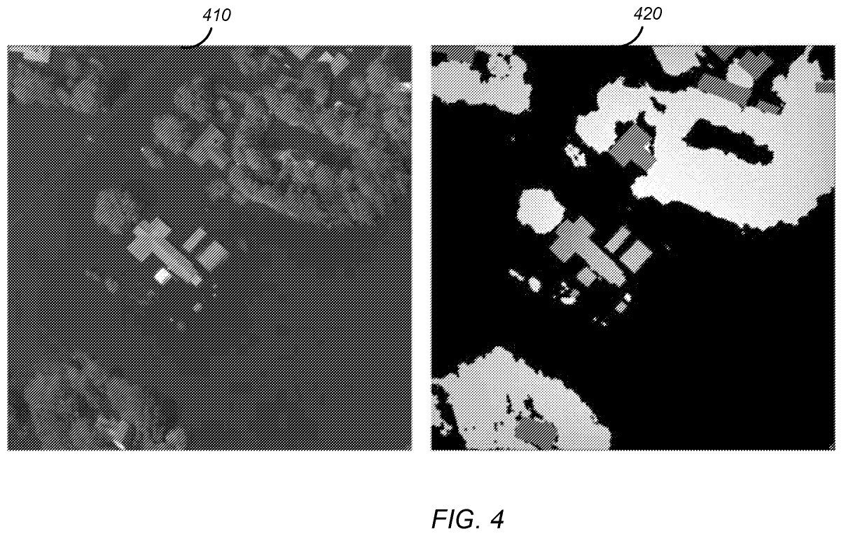

There are several approaches for producing such supplemental data, each of which may be used in combination with the primary data 304 provided to the damage detector. In one example approach, the primary sensor data itself may be used to generate, via an independent damage detection model 330 (implemented as a trained learning machine, or as a filtered-based module that applies pre-determined filtering processing to the primary image data or to other sensor data), the damage-index data. When the detector 330 is implemented as a trained learning machine, image data (for example, the visible range image data that had been stored in a repository 322) is provided to the learning engine 330, which may have been trained to implement a semantic segmentation model (where regions of pixels are labeled, e.g., through assigned color codes, to represent certain features in the image), to identify areas affected by one or more types of damage (such as water, or burn areas). The damage-index data generator 330 outputs, in response to the primary image data (which may be visible range data), output data indicative of regions within the geographic area (corresponding to the input image provided) that are affected by one or more types of damage. For example, and with reference to FIG. 4, an input image 410 is provided to a detector (such as the detector 330 of FIG. 3) that produces semantic segmentation output 420, in which regions corresponding to water are labelled or marked with one type of color or shade, vegetation is marked/labelled with another shade or color, and other structures are marked or labelled with a third color or shade. In embodiments in which the detector 330 is implemented as a learning machine, training of the detector 330 may include providing training data that includes data representative of various types of damages (e.g., fire damage, water body) that occurred in different geographical locales, so that the damage detector is configured to recognize during runtime damage-causing events no matter the specific geographical locale corresponding to the current incoming data.

In some embodiments for flooding events, the water body segmentation can be further improved by digital elevation models (DEMs) whenever available, since the water surface should be flat. The detector 330 may be configured to compare the water segmentation map to the building structure segmentation map. The relative position between the water body and building is indicative of the flood damage. For example: buildings close to center left of 410 of FIG. 4 are determined to be surrounded by water on four sides based on the segmentation map output (420 of FIG. 4), and thus, from the model, such buildings most likely suffered flood damage.

In some embodiments, the detector 330 may be configured to compare a current input image to an earlier baseline image (such baseline images may be stored in a baseline image repository 312 or in the repository 322) and to output data that is indicative of changes or deviations in the locations of certain features relative to the earlier baseline data (e.g., determining whether the location of the water line from the baseline image has shifted in a way that indicates possible flooding damage). In embodiments where the detector 330 implements a differential model, some pre-processing, such as data aligning (e.g., based on geo-reference data that may be associated with the current and earlier baseline data) may be performed by the detector 330 or by some other upstream processing module.

As further depicted in FIG. 3, in some embodiments, the damage-index data may be generated based on additional sensor data, for a particular geographic area, other than the visible range data. For example, the geospatial data acquired by the overhead platform passing over a geographical area (such as the area 110 of FIG. 1) may include multiband data such as the data represented by the graph 200 of FIG. 2. More particularly, the data of the graph 200 (typically captured by multiple sensor instruments, that are each attuned to a particular range of wavelength, but may be captured by a single device), represents the captured level of EM reflections by the particular surfaces covering the geographical area 110. Different materials are known to have different reflectance profiles over a range of the EM bands. For example, overlaid on the graph 200 (which is representative of an example profile of captured EM reflection levels for some particular location in a geographical area) are curves 210, 212, 214, and 216 showing example reflectance profiles for snow, sand, water, and vegetation, respectively. Thus, knowing the reflectance levels at different EM band can help independently determine or infer the nature of the surface that caused that level of reflection. For example, a high level of reflectance at the short-wave infrared range (SWIR) can indicate that the surface is rocky (since at that band reflectance levels for a rocky terrain are more pronounced than for water, vegetation, or snow), and has sparse vegetation, thus suggesting that the locations where that high level of reflection is present may have been damaged by fire.

To generate the damage-index data, the multiband geospatial raw data captured by the one or more sensors is converted (e.g., if multiple sensors are needed to capture data for a particular band, some transformation, possibly based on linear weighing of the measurements produced by such multiple sensors) and arranged into one or more band image matrices 220, 222, and 224. In the example of FIG. 2, sensor data for the visible range (e.g., captured by a CCD or CMOS-based light-capture array) is converted and arranged into the primary image data matrix 220, sensor data captured by the near infrared (NIR) sensor(s) are converted and arranged into the NIR image matrix 222, and sensor data captured by the short-wave sensor(s) is converted into the SWIR image matrix 224. Additional or different matrices, covering different EM bands may also be generated. The generation of the band matrices (such as the matrices 220, 222, and 224) may be performed at the overhead platforms 120 or 122 of FIG. 1, or may be performed at the system 150 (or 300) after the raw sensor data is transmitted from the platforms to the detection system via the communication nodes (130, 132, or 134) of FIG. 1. In the example system 300 depicted in FIG. 3, the processing of the geospatial band data is performed by the damage-index data generator 320 using the optional data filters 326 (which can be multi-band filters). The data filters module may generate more data sets than the actual number of band image matrices that are used, and may thus combine, filtered data for multiple sub-bands (e.g., data for multiple NIR sub-bands) by creating a single composite NIR image matrix according to some pre-determined linear weighing of the respective levels produced for the different sub-bands.

Having arranged the multiband sensor data into appropriate multiband image matrices (whether performed by the data filters 326 of FIG. 3, or by an equivalent module housed in one of the overhead platforms 120 or 122, or elsewhere en route to the system 150 or 300), damage-index data (arranged, for example, as damage-index images) is generated. In FIG. 3, a damage index processor may generate one or more damage-index images representative of the presence of different damage-causing characteristics. For example, burned areas and areas of healthy vegetation typically have different NIR and SWIR reflection level characteristics. Accordingly, a burn (fire) damage-index image, representative of regions within a particular geographical area that may have suffered fire damage (as may be indicated by a normalized burn ratio, or NBR, level computed per pixel in the image) can be computed from the NIR and SWIR damage-index images according to the example formulation:

$$N B R = ( \frac{{x}_{NIR} - {x}_{SWIR}}{{x}_{NIR} + {x}_{SWIR}} )$$

where x_{NIR} is a near infrared component value of a pixel (or location) within the damage-index image, and x_{SWIR} is a short-wave infrared value of the pixel. Other formulation, using NIR and SWIR values, or using additional or other EM band-related data, may be used.

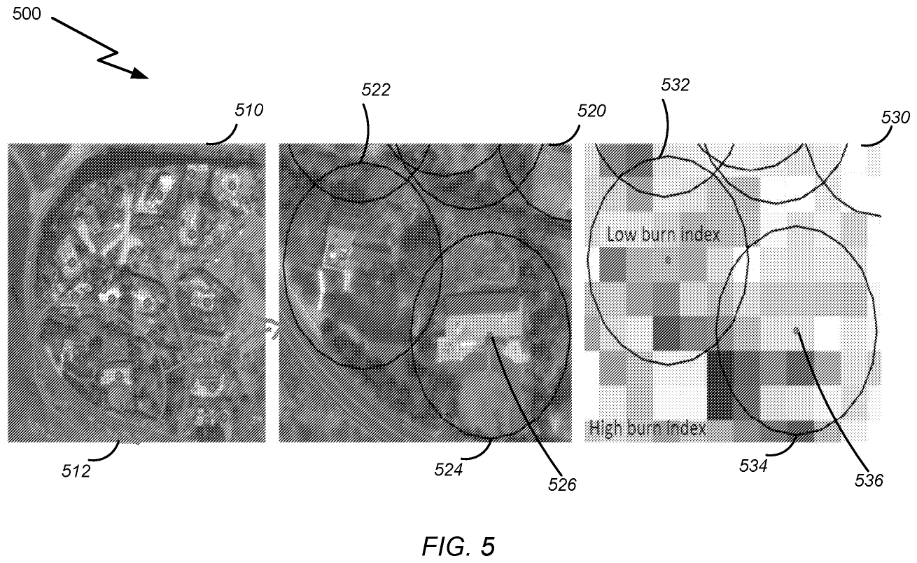

FIG. 5 includes an example illustration 500 of the use of NBR to identify regions within a geographical area that may have suffered fire damage. Image 510 is an annotated overhead photograph of a geographical area. A circled region 512 in image 510 indicates a magnified portion of the image 510 that is shown in image 520. Two main sub-regions are marked in the magnified image 520, namely a region 522 and a region 524. The image 520, as well as the image 510, are both visible range photos of the particular geographical areas. To generate NBR image, corresponding NIR and SWIR images are acquired (obtained by sensors working in conjunction with the camera that captured the image 510). The NIR and SWIR can then be used to generate an NBR image (burn-index image) corresponding to the visible range image. In the example of FIG. 5, a portion of an NBR image 530, corresponding to the region shown in the magnified image 520, is provided. In a region 532 marked within the NBR image 530, the resultant NBR representation (which may have been computed based on the NBR formulation above) indicates a low burn index. This representation (using different colors or shades to indicate the burn level) is consistent with the visible range imaging of that same geographical region. For example, the region 522 includes relatively widespread vegetation. NIR and SWIR data for that region would therefore result in shading corresponding to low-burn index. On the other hand, the neighboring region 524 in image 520 has relatively sparse vegetation, and in fact includes a large swath of rocky terrain. The corresponding shading for that region (as illustrated within the portion 534 of the burn-index image 530) provides a representation of a high burn index. This high burn index does not necessarily mean that the area has been damaged by fire, but does indicate that there is an increased likelihood of a fire event (especially when juxtaposed next to a sub-region with more sparse vegetation). The decision on whether a particular region was damaged by fire may depend on additional information, which may be analyzed by a learning machine (trained to make optimized decision based on a detection model that combines data from various sources and different criteria).

As also illustrated in FIG. 5, in some embodiments, the NBR image 530 is segmented to squares of equal sizes, each having uniform shading or color. This representation can be achieved through a determination of average value within a square sub-region, and quantizing the average value into one of several pre-determined values that may be used to represent the NBR image. Such processing can reduce the amount of noise that results in small value deviations between neighboring pixels, and provide a more intelligible representation of potential burn areas within a geographical region. Other processing technique to process the NBR data computed based on NIR and SWIR data (and/or other sources of data) can also be used.

Another example of an independent approach for determining damage-index data, in this case for water damage, is the derivation of water-index to monitor changes related to water content in water bodies, based, for example, on the green component and NIR component of the captured multi-band data. In some examples, the water-index, also known as the normalized difference water index (NDWI), can be computed from the green and NIR data (whether represented using image matrices, or in some other data structure or representation) according to the example formulation:

$$N D W I = ( \frac{{x}_{green} - {x}_{NIR}}{{x}_{green} + {x}_{NIR}} )$$

where x_{green} is a green component value of a pixel (e.g., in a visible range image matrix, such as the matrix 220 of FIG. 2), and x_{NIR} is a near infrared value of the pixel (as determined, for example, from a data structure such as the image matrix 222 of FIG. 2). Other formulation, using data from other bands (including SWIR, or other EM band-related data) may be used.

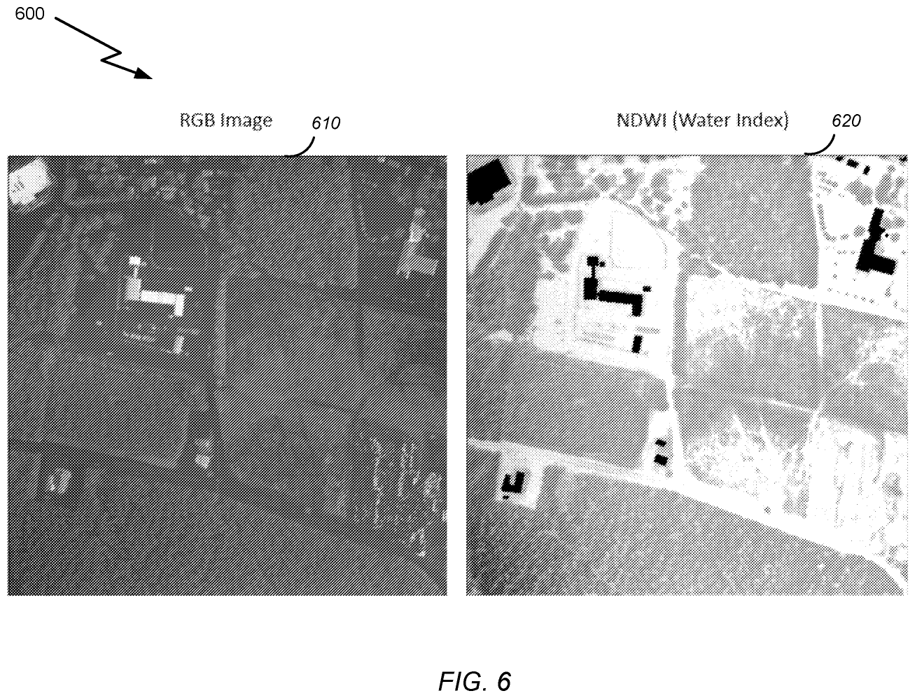

FIG. 6 includes an example illustration 600 of the use of NDWI to identify regions within a geographical area that may have suffered water damage. Image 610 is an overhead photograph of a geographical area. NIR and visible range data corresponding to the image 610 are used to identify locations within the image that include water. It is noted that supplemental multiband data may have been acquired by sensors mounted on the same platform as the visible range camera, and thus such supplemental data may be substantially spatially aligned with the data from the visible range camera. Nevertheless, in some situations, some data alignment may be needed to ensure that data from different sensors are used for the same geospatial locations.

As shown in the NDWI image 620 corresponding to the image 610, locations within the image 620, that correspond to water surfaces located within the image 610, are identified. In some embodiments, segmentation processing (to identify and mark) certain sub-areas as corresponding to the same features, even if there is some small deviation between values of neighboring locations, may be performed on NDWI data in order to generate the NDWI image 620. For example, adjacent pixels within a particular range may be set to a uniform pre-determined value (e.g., NDWI data within some pre-determined range that is associated with water may result in a corresponding pixel value of the NDWI image 620 being set to a value representing white, or some other greyscale shade). The NDWI image 620 allows determination of which sub-areas within the image 610 correspond to objects that possibly correspond to water damaged objects. A decision on whether a particular region within a geographical area was damaged by water may depend on additional information, which may be analyzed by a learning machine (trained to make optimized decisions based on a detection model that combines data from various sources and different criteria).

Yet another example approach of obtaining damage-index data, in this case for vegetation burn damage, is the derivation of a vegetation-burn-index to monitor changes, related to vegetation damage, based, for example, on the red component and NIR component of the captured multi-band data. In some examples, the vegetation-burn-index, also known as the normalized difference vegetation index (NDWI), can be computed from the red and NIR data (whether represented using image matrices, or in some other data structure or representation) according to the example formulation:

$$N D V I = ( \frac{{x}_{NIR} - {x}_{r e d}}{{x}_{NIR} + {x}_{r e d}} )$$

where x_{red} is a red component value of a pixel (e.g., in a visible range image matrix, such as the matrix 220 of FIG. 2), and x_{NIR} is a near infrared value of the pixel (as determined, for example, from a data structure such as the image matrix 222 of FIG. 2). Other formulation, using data from other bands (including SWIR, or other EM band-related data) may also be used to derive the NDVI index, or some other type of damage-index.

As further shown in FIG. 3, in some examples, the data repository 322 can also receive and store prior-knowledge data and/or other independent sources of data that provide information on the possibility of sustaining damage in the geographical area in question. Prior-knowledge data (also referred to as “supplemental data”), examples of which include historical flood data, historical wind speed data at various regions in the geographical area, recent data representative of fire paths in the geographical area, weather maps (historical and contemporaneous), etc., is typically obtained in advanced of the acquisition of the image data to be analyzed. The prior-knowledge data can be used alone or in combination with the other data records stored in the repository 322, to generate damage index data. For example, historical data representative of historical flood data can be processed by the data filters 326 to generate clusters representative of regions (within a geographical area) associated with different likelihood levels of water damage occurring. Such damage index data may be combined with similar damage index maps generated from multi-band data, or from damage index maps produced by the learning engine 330, to provide a composite damage index map that is communicated to the damage detector to facilitate performing damage analysis on the primary image data.

Other techniques and approaches to determine damage-index data (for water damage, fire damage, wind damage, and other types of damage) may also be realized using the data collected at the repository 322 and the processing performed via the damage-index processor.

Thus, and with reference again to FIG. 3, the damage-index data generator is configured to obtain, using geospatial sensor data for the geographical area being analyzed, damage index data (e.g., by processing data for one or more EM bands, performing a segmentation operation on a photograph of the geographical area using a learning engine, or according to some other technique to generate damage index data) provided to the damage detector 310, and used, by the detector 310, as one of the independent sources of information based on which the detector 310 detects and/or determines the extent of damage. The damage detector 310 also receives as input image data (typically a photograph taken by a visible range light capture device) and processes the received data (the visible range data and the damage-index data) to determine/identify one or more objects that might have suffered damage, and optionally the extent of damage suffered by such objects.

In some embodiments, determination of damaged objects identifiable in the geographical area corresponding to the scene can be performed by first applying an object identification machine learning model to the primary image data (e.g., the data corresponding to the visible range photograph), or alternatively to aligned pre-imagery (the localization of structures and other permanent objects can be done on pre-event imagery instead of on the post-event imagery in some cases), to identify objects appearing in the scene. This may result in output in which the output data includes a representation of the scene overlaid with markings or annotations indicating the locations of certain objects appearing in the image of the scene. Alternatively, the output may be data records identifying location, characteristics, and other relevant metadata for one or more potentially damaged objects in the scene. In such embodiments, the output data from the object identification stage is compared to the one or more damage-index data, e.g., by overlaying identified one or more objects on the damage-index image generated by the generator 320. This comparison of the primary data with the supplemental data (i.e., the damage-index data) produces output representative of the overlap between regions in which various identified objects are located, and regions that may have potentially been affected by a damage-causing event. For example, and with reference again to FIG. 5, typically, the damage-index generator would produce, in examples involving potential fire damage, a burn-index image mosaic-like image similar to the image 530, but without the markings or annotations (such as the regions 532 or 534). An object-identification machine learning model (implemented as part of the damage detector 310, or implemented at an upstream module, such as the optional pre-processing module 340 depicted in FIG. 3) may be configured to produce output, such as the image 520, containing markings identifying detected objects (in this case, dots, like the dot 526, overlaid on a corresponding structure, although other types of markings, including geometrical approximations of the outlines of the structures detected, may be used). Overlaying a marked image containing identified objects/structures on the damage-index 530 indicates overlap between a region containing an identified structure (labelled by the dot 536 within the region 534) and a corresponding region with a relatively high likelihood of fire-damage. The determination of overlap between a region with a relatively high degree of potential damage, and a region containing a structure (e.g., in this example, the structure represented by the dot 536), may be made in situations where the structure is within some pre-determined radius from a sub-area identified as having a relatively high degree of potential damage, and the sub-area with the potential damage covers some pre-determined percentage of the region being analyzed (e.g., more than 25% of the region's area). Under such criteria, the structure 536 within the region 534 of the image 530 may be determined to have a high degree of likelihood of having been damaged by fire. Other criteria and thresholds may be used in the analysis of identifying damage to identified objects/structures.

In some embodiments, the identification of objects that may have suffered damage may be accomplished by training a learning machine to accept both damage-index data and primary visible range image data as its input, and to produce data indicating regions within the primary image that contain objects that could have been damaged by the damage type associated with the damage-index data produced by the generator 320.

Another example approach of incorporating supplemental information, such as damage-index data, to facilitate damage detection process, is to use the independently determined damage-index data to adjust a detection sensitivity level of a damage detection model so that regions/clusters within the geographical area being analyzed that are determined to have a higher likelihood of damage (e.g., the damage index data indicates that those regions may have suffered fire, wind, or water damage) produce output reflective of the higher probability of possible damage (since the identification of damaged or undamaged objects are generally spatially correlated). Such an increase in sensitivity is typically associated by a higher false-positive rate of detection (e.g., an object may incorrectly be identified as having suffered damage, or the extent of damage may be overestimated), but since the damage-index data indicates the region is likely to have suffered damage, such a trade-off is considered to be acceptable in order to derive at least an initial estimate of the extent of damage affecting a region. As will be discussed in greater detail below, other independent sources of information to adjust damage detection sensitivity used for different clusters, or regions, of the image data being analyzed, include historical information typically obtained in advanced of the acquisition of the image data to be analyzed. Examples of such historical information include historical flood data, historical wind speed data at various regions in the geographical area, recent data representative of fire paths in the geographical area, weather maps (historical and contemporaneous), etc.

Generally, in the approach to adjust the sensitivity level of the detection model, a deep neural network or classifier is trained using a training dataset which may have a uniform class distribution. This model can then be used to predict classes for every sample in a new dataset with an unknown class distribution. Such an approach is akin to using a Bayesian model with uniform priors. Because geospatial data (image data acquired by a light-capture device mounted on a satellite or aerial vehicle) is used, samples of that data tend to be spatially correlated (i.e., nearby samples tend to have similar properties). A clustering process, such as k-means process, can be used to cluster the data into spatial partitions. This can be done in multiple ways, including: 1) using geospatial satellite-derived indexes, e.g., computing a burn index for wildfire, a water index for a flooding event, etc., according to the techniques described herein, 2) using predicted class probabilities from the neural network, 3) using other high-level features discovered by computer vision algorithms, etc. Once these clusters are defined, the trained classifier is applied at various operation points (different probability thresholds), for different clusters/regions, on a precision-recall (also referred to as a receiver operation curve, or ROC) associated with the model to optimize the cost of error. For example, for a cluster with most of the undamaged houses, the behavior of the model at that cluster should be optimized for high precision (low false positives). On the other hand, a cluster that likely has many damaged houses (as may be determined a priori based on historical data indicating susceptibility to floods, or based on contemporaneous damage-index data), the model's behavior in that cluster/partition should preferably be optimized for high recall (low false negatives).

An example of operations that can be performed to make class predictions for each cluster based on geospatial damage index data (e.g., fire-index data, water-index data, etc.) is the following process:
a) Use a damage-index map/image to generate initial map clustering and prior distribution within each cluster.
b) Modify the predictions using this new probability distribution as the prior distribution in a Bayesian model.
c) Generate new prediction results (that may be reported) by combining all clusters.

The approaches described herein for adjusting sensitivity levels for detection models can maximize a model's inference (prediction) overall accuracy compared to the baseline approach (where the prior distribution is not estimated). Using clustering also minimizes underprediction of minority classes which are often of greatest interest in remote sensing applications. The present approaches leverage spatial correlation between samples within a dataset to inform predictions and geospatial satellite-derived feature indices (providing improved prediction performance over implementations that run inference using a neural network with no post processing). The sensitivity level approach typically only requires inference to be run on the neural network one time. Geospatial data-derived feature indexes are also helpful for balanced training dataset generation. For example, with a burn-index, a dataset can be pre-filtered to approximately balanced burned houses and undamaged houses before providing the data for labeling. This could potentially reduce the computational cost associated with labeling to generate training data (as compared with the computational cost to perform labeling for an unbalanced dataset where multi-band information is not available).

When implementing the detection sensitivity approach using damage-index data derived from contemporaneous geospatial data (e.g., acquired by a satellite or aerial platform), adjustment of a sensitivity level of the damage detector can be realized by dividing the primary image data (e.g., the visible range data) into portions according to the independently generated damage-index data. The primary image data can be divided into equal-sized regions (e.g., corresponding grid-based portions such as the squares in the burn index image 530), or into variable-size portions based on statistical characteristic of the damage-index data (e.g., contiguous portions in which the computed index values corresponding to the damage index data are within some variance metric or criterion from the averages/means for those respective portions), or using some other clustering technique. In some embodiments, the clustering procedure may seek to determine an optimal number of clusters that achieves some optimization criteria (e.g., minimizing the variance within each cluster). At the conclusion of the clustering process, the index-data is partitioned into multiple portions, with each cluster associated with a value (e.g., the average index value within the cluster) based on which the detection sensitivity level for the detection model in different clusters/regions is adjusted.

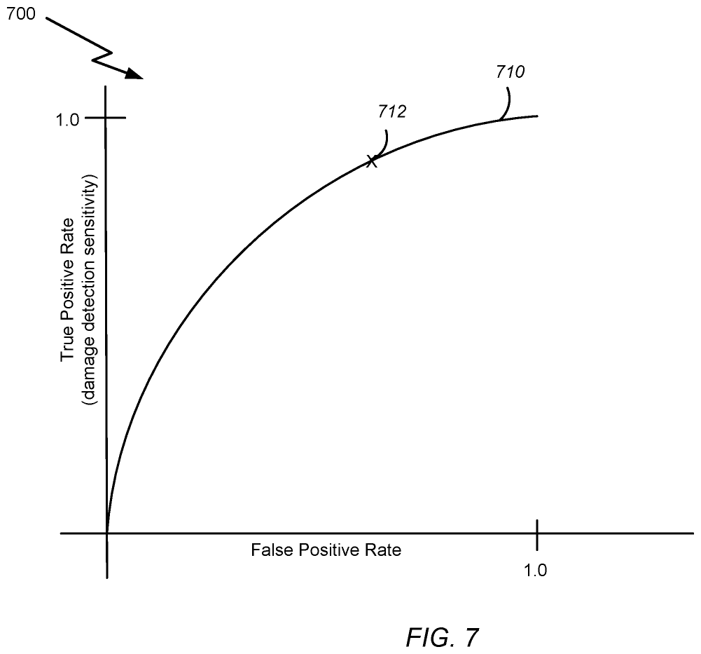

As noted, in some examples, the adjustment of sensitivity levels for the different partitioned portions is performed according to a receiver operation curve (ROC), which is also referred to as a precision recall curve. For convenience, throughout the present description, the term ROC curve will be used. In the present examples, the adjustment of the sensitivity level includes dynamically tuning an operation point for the ROC for a particular portion of the image data based on likelihood of occurrence of damage, determined based on the damage-index data, in a region within the geographical area so as to adjust a false-positive detection rate of the detection model, or adjust a detection sensitivity value for the detection model within the region. For example, consider FIG. 7 which includes an example graph 700 with an ROC 710 to control the damage sensitivity for a particular region in an image representative of a geographical area (such as the area 110 of FIG. 1). The ROC 710 defines the relationship between a true positive rate (i.e., the damage sensitivity) and the false positivity rate. The curve includes an adjustable operation point 712 that can be adjusted by decreasing or increasing the rate, which results in a corresponding change to the true positive rate. By increasing the false positive detection rate of the curve 710, the true positive rate (i.e., the rate at which a particular object will correctly be identified as damaged) is also increased. The adjustment of the rate is performed according to the damage index data so that sub-areas, in the geographical area, that have been determined to have an increased probability of being affected by potential damage (e.g., because those sub-areas are determined to have been affected by flood water, or by fire damage, as may be determined from multiband geospatial data or from other sources of data from which damage-index data is derived), will have the sensitivity (e.g., the true positive rate) increased by increasing the false positive rate to be used for the detection model being applied to the respective image portion.

When implementing the detection sensitivity approach using prior knowledge (historical information such as flood maps, weather reports, and types of prior knowledges that indicate likelihood of occurrence of damage at various locations), adjustment of a sensitivity level of the damage detector is performed similarly to the way the sensitivity adjustment is performed using contemporaneous geospatial data, except that the historical information typically does not need to be derived, but is instead received from some remote repository that maintains the historical data. Here too, the primary image data (e.g., the visible range data) is divided into portions according to partitioning pf the historical information data (e.g., based on a clustering technique applied to the historical data). The index values associated with the partitioned historical data are used to adjust the sensitivity levels of the damage detection model applied to corresponding portions of the primary image data.

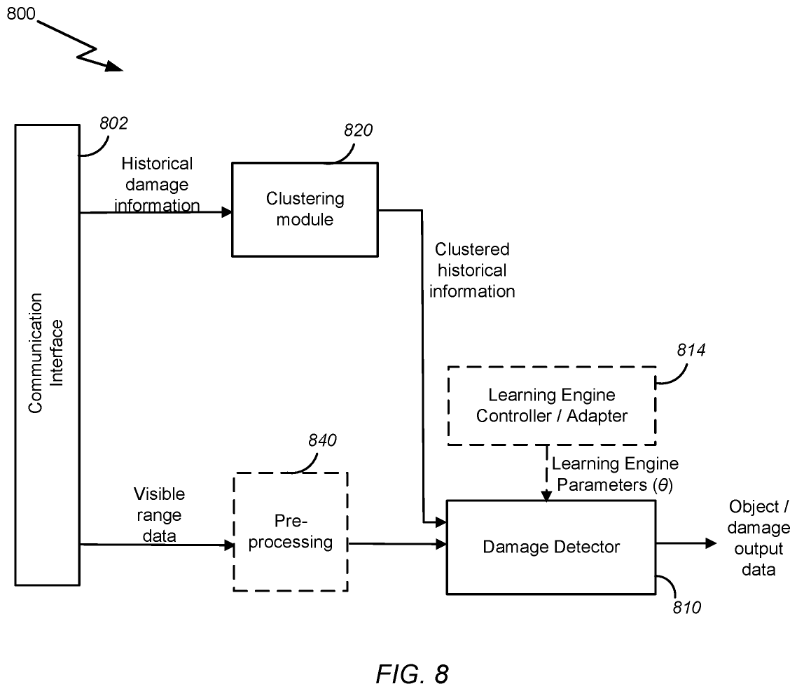

FIG. 8 is a block diagram of an example damage detection system 800 using historical information. The system 800 receives historical information (or other types of prior knowledge data) and primary image data for a particular geographical area via a communication interface 802 (which may be similar to the communication interface 302 of FIG. 3). The historical damage information is provided to a clustering module 820 that perform a clustering (e.g., a k-mean clustering process, or some other clustering technique) to identify portions/regions in the historical information data (and thus in the image data) associated with respective likelihood levels of being affected by damage-causing events (such as floods, winds, fire, etc.) The clustered historical information is provided to a damage detector 810 which, like the damage detector 310 of FIG. 3, has been configured to detect damage to one or more objects identified in the primary image data (the visible range data for the geographical area being analyzed). The damage detector may have initially (and optionally intermittently, during runtime) been trained according to training data processed by a learning engine controller adapter 814 (which may be implemented similarly to the controller/adapter 314 of FIG. 3). The clustered historical information adjusts damage detection sensitivity levels that are applied to different portions of the primary image data (with such portions corresponding to the portions determined by the clustering module according to the historical damage information. Such sensitivity adjustment may be implemented according to one or more ROC curves, with each portion of the image being processed according to ROC operation points that are determined according to values associated with the resultant clusters of the historical damage information. The implementation of FIG. 8 may also be used in embodiments in which contemporaneous damage-index data is provided instead of prior knowledge data, except that the input data to the clustering module 820 would be the output of a damage-index data generator such as the generator 320 of FIG. 3

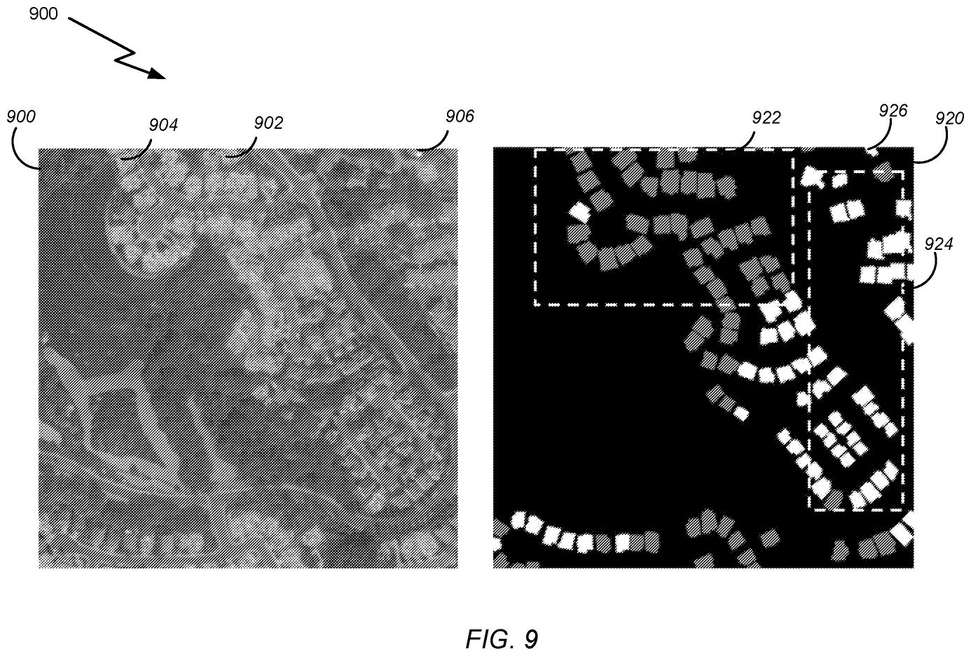

FIG. 9 includes an illustration of the use of a sensitivity-adjustable damaged detection (prediction) model. As shown, an overview photograph 900 of some geographical area that has been impacted by fire is provided. The photograph shows badly damaged structures in one region of the photo (e.g., the objects 902 and 904 are two examples of badly damaged homes), and homes that are generally undamaged in another area of the photo. Image 920 is an example of a resultant output image produced by a detector (such as the detector 800 of FIG. 8). Although not shown in FIG. 9, a burn index corresponding to a fire event that impacted the geographical area in FIG. 9 had been provided to the detection system, based on which the index data, and subsequently the photo 900, are partitioned into clusters containing substantially homogeneous elements (the clustering may have been performed according to one of the clustering/partitioning techniques described herein). The output image 920 illustrates two such clusters, namely the cluster 922, corresponding to the region of the geographical area with burn index values corresponding to high probability of fire damage to objects located in that region, and a cluster 924 corresponding to another region with burn index values corresponding to low probability of fire damage inflicted on objects or structures within that region. The values associated with the burn indices within the determined clusters (e.g., an average index value for a cluster would be reflective of the likelihood of damage) is used, in the example of FIG. 9, to adjust operations point for the detection model that is to be applied to image data in the various clusters (such as the clusters 922 and 924) to control the prediction behavior of the model. For example, for the image data corresponding to the cluster 922, the burn index values indicate a high probability of damage occurring to objects within that region, and therefore the sensitivity level for the detection model when applied to that cluster is increased (e.g., by moving the operation point for an ROC associated with the model to increase its true-positive rate). Thus, for the image data in that cluster, image data which represents a borderline case between damaged or undamaged could, with an increased sensitivity level, be predicted to be damaged. As shown in FIG. 9, within the cluster 922, all but one discernable object (the white structure) is identified as having been damaged. On the other hand, consider the structure 906 shown in the photo 900. The details of that structure are somewhat ambiguous as to whether that structure is damaged or not. Because the structure is outside the cluster 922 (the corresponding output element representative of the structure 906 is the marked as 926), and is located in a sub-area for which a lower detection sensitivity level is used, the structure 906 is determined by the detection model to be an undamaged structure.

Turning back to FIG. 3, in some examples, determination of the existence of damage may also be based on a differential model to determine whether there has been deviation in the dimensions/shapes of detected objects or structures in a current image from what was detected in earlier baseline images. Such embodiments may be useful when only slight damage can be identified through the differential model (e.g., in the situations where the differences are subtle enough that they could be attributed to noise or to imprecise data captures), in which case the damage index data can provide further corroboration of the potential existence of damage to the structure. For example, if there are small deviations in the outlines or dimensions of an object detected in a current and baseline image, the determination of whether the differences in the shape and dimensions of the object between the baseline and current images represent damage to the object can be based on the damage index information for the region containing the object in question (e.g., damage index level indicating occurrence of a damage-causing event can lead to a determination that the object has suffered damage). Conversely, the existence of differences between a baseline image and the current image can provide further corroboration for designating regions in the damage-index data as representative of the occurrence of a damage-causing event.

In embodiments in which a differential damage detection model is used, the damage detector 310 may be trained using grounds truths stored in a baseline image repository 312. The use of a differential model may also require additional processing to be performed on the baseline images used for training or later during run time operations. Such processing may include image aligning, segmenting, or processing the baseline image to generate compact data representative of the content and/or classification of the data. For example, baseline images are generally associated with positioning information identifying the particular geographical areas for which the baseline images. The specific baseline image to be compared to the current image received at the system can be selected based on positioning information associated with the current image.

Optionally, in some embodiments, the incoming image may undergo pre-processing (prior to being provided to the damage detector 310) by the pre-processing unit 340 to, for example, align the incoming current image with its corresponding baseline image (e.g., based on geo-referencing information). The pre-processing unit 340 may optionally also identify certain features in the image and/or mark objects appearing in the incoming current image with geometrical shapes (e.g., dots, rectangles, or more complex polygonal shapes). Such processing can be performed using a learning engine (which may be different from the learning engine implementation of the damage detector 310), or via filtering-based procedures. The images may further be formatted, e.g., using a pre-processing procedure, into records of sizes and types that are compatible with the expected inputs to the damage detector (e.g., into vectors or matrices of pre-determined dimensions).

The learning engines used by the damage detection system 300, including the damage detectors 310 or 810, and/or learning engines used for other operations (e.g., the learning engine damage-index generator 330) may be implemented as neural networks. Such neural networks may be realized using different types of neural network architectures, configuration, and/or implementation approaches. Examples neural networks that may be used include convolutional neural network (CNN), feed-forward neural networks, recurrent neural networks (RNN), etc. Feed-forward networks include one or more layers of nodes (“neurons” or “learning elements”) with connections to one or more portions of the input data. In a feedforward network, the connectivity of the inputs and layers of nodes is such that input data and intermediate data propagate in a forward direction towards the network's output. There are typically no feedback loops or cycles in the configuration/structure of the feed-forward network. Convolutional layers allow a network to efficiently learn features by applying the same learned transformation(s) to subsections of the data. Other examples of learning engine approaches/architectures that may be used include generating an auto-encoder and using a dense layer of the network to correlate with probability for a future event through a support vector machine, constructing a regression or classification neural network model that indicates a specific output from data (based on training reflective of correlation between similar records and the output that is to be identified), etc.

Implementation using neural networks can be realized on any computing platform, including computing platforms that include one or more microprocessors, microcontrollers, and/or digital signal processors that provide processing functionality, as well as other computation and control functionality. The computing platform can include one or more CPU's, one or more graphics processing units (GPU's, such as NVIDIA GPU's), and may also include special purpose logic circuitry, e.g., an FPGA (field programmable gate array), an ASIC (application-specific integrated circuit), a DSP processor, an accelerated processing unit (APU), an application processor, customized dedicated circuity, etc., to implement, at least in part, the processes and functionality for the neural network, processes, and methods described herein. The computing platforms used to implement the neural networks typically also include memory for storing data and software instructions for executing programmed functionality within the device. Generally speaking, a computer accessible storage medium may include any non-transitory storage media accessible by a computer during use to provide instructions and/or data to the computer. For example, a computer accessible storage medium may include storage media such as magnetic or optical disks and semiconductor (solid-state) memories, DRAM, SRAM, etc. The various learning processes implemented through use of the neural networks may be configured or programmed using TensorFlow (an open-source software library used for machine learning applications such as neural networks). Other programming platforms that can be employed include keras (an open-source neural network library) building blocks, NumPy (an open-source programming library useful for realizing modules to process arrays) building blocks, etc.

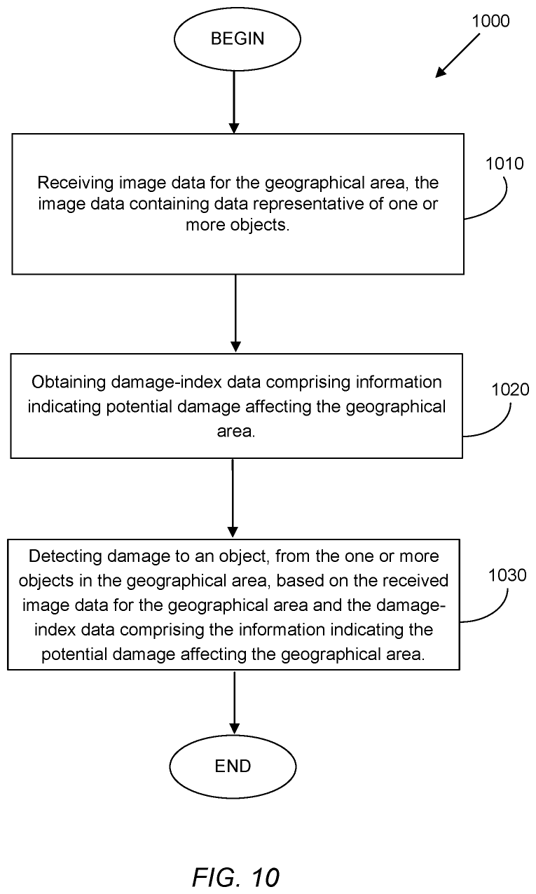

With reference next to FIG. 10, a flowchart of an example procedure 1000 for detecting damage in a geographical area is shown. The procedure 1000 is typically performed at a system such as the damage detection system 150 of FIG. 1, the system 300 of FIG. 3, or the system 800 of FIG. 8. The procedure 1000 includes receiving 1010 image data for the geographical area, with the image data containing data representative of one or more objects. Typically, the image data is acquired by a light-capture device (such as a CCD or CMOS-based device) mounted on a platform such as the satellite 120 or the aerial platform 122 of FIG. 1. The procedure 1000 further includes obtaining 1020 damage-index data comprising information indicating potential damage affecting the geographical area, and detecting 1030 damage to an object, from the one or more objects in the geographical area, based on the received image data for the geographical area and the damage-index data comprising the information indicating the potential damage affecting the geographical area.

In some example, detecting damage to the object based on the received image data for the geographical area and the damage-index data may include generating one or more damage index images from the obtained damage index data (to represent the damage-index data in image form that can be matched-up to the visible range image), and detecting damage to the object based on the received image data and the one or more damage index images. The image data for the geographical area may include multi-band geospatial data. In such embodiments, obtaining the damage-index data may include filtering the image data comprising the multi-band geospatial data to extract band data, for the geographical area, to identify one or more types of damage, and generating the one or more damage-index images may include generating, based on the extracted band data, the one or more damage index images identifying portions within each of the one or more damage-index images that potentially are affected by the respective one or more types of damage.

In examples in which multi-band geospatial data is obtained, filtering the image data may include filtering the image data to extract one or more of, for example, RGB band data for the image, false color composite data for the image (e.g., NIR+R+G), and/or RGB band data for the image plus infrared band data for the image.

Other resultant filtered data set may be extracted from the obtained multi-band geospatial data. In such embodiments, the procedure 800 may further include determining regions in the geographical area associated with data representative of presence of water, including generating a normalized difference water-index (NDWI) image, corresponding to the image data for the geographical area, by computing each pixel of the water index image according to

$$N D W I = ( \frac{{x}_{green} - {x}_{NIR}}{{x}_{green} + {x}_{NIR}} )$$

where x_{green} is a green component value of a pixel of the NDWI image, and x_{NIR} is a near infrared value of the pixel.

In some examples, the procedure may further include determining regions in the geographical area associated with data representative of potential fire damage, including generating a normalized burn ratio (NBR, which is also referred to a fire-index) image, corresponding to the image data of the geographical area, by computing each pixel of the fire index image according to

$$N B R = ( \frac{{x}_{NIR} - {x}_{SWIR}}{{x}_{NIR} + {x}_{SWIR}} )$$

where x_{NIR} is a near infrared component value of a pixel of the NBR image, and x_{SWIR} is a short-wave infrared value of the pixel.

In yet further examples, the procedure may additionally include determining regions in the geographical area associated with data representative of potential fire damage with respect to vegetation content, including generating a normalized difference vegetation index (NDVI), corresponding to the image data of the geographical area, by computing each pixel of the fire index image according to

$$N D V I = ( \frac{{x}_{NIR} - {x}_{r e d}}{{x}_{NIR} + {x}_{r e d}} )$$

with x_{NIR} being a near infrared component value of a pixel of the image, and x_{red} being a red component value of a pixel of the image.

Generating the one or more damage index images may include applying a damage detection model, implemented on a learning machine, to the received image data for the geographical area to detect regions in the received image data associated with respective one or more types of damage. Detecting damage to the object based on the one or more damage index images may include detecting at least some of the one or more objects in the received image data, and determining overlap between the detected at least some of the one or more objects in the received image data and regions of the one or more generated damage-index images comprising data representative of respective types of damage.

As noted, in some implementations, damage detection can utilize damage-index data to control sensitivity levels in a Bayesian-based damage detection framework. In such implementations, detecting damage to the object may include dividing the image data into multiple portions according to the damage index data, and for each of the multiple portions of the divided image data, applying a damage detection model with an adjustable detection sensitivity level, including controlling the adjustable detection sensitivity level based on a portion of the damage-index data corresponding to the respective portions of the divided image data. The adjustable sensitivity level may be controlled according to a receiver operation curve (ROC) representation. In such examples, applying the damage detection model may include dynamically tuning an operation point for the ROC for a particular portion of the image data based on likelihood of occurrence of damage, determined based on the damage-index data, in a region within the geographical area to adjust a false-positive detection rate of the detection model, or to adjust as a function of a detection sensitivity value for the detection model within the region. Dynamically tuning the operation point for the ROC may include one of, for example, decreasing the detection sensitivity value for the detection model to cause a decrease in the false-positive detection rate within the region, or increasing the detection sensitivity for the detection model to cause an increase in the false-positive detection rate within the region.

Applying the detection model may include adjusting the detection sensitivity levels for a first region and for a second region in the geographical area so that a likelihood of identifying a first object in the first region as being damaged is higher than a likelihood of identifying a second object in the second region as being damaged, when the damage-index data indicates that a likelihood of occurrence of damage in the first region is higher than a likelihood of occurrence of the damage in the second region. Applying the detection model may include applying a detection model implemented as a binary classifier.

Controlling the adjustable detection sensitivity level may include adjusting a discrimination threshold of the binary classifier. Controlling the adjustable detection sensitivity level may include increasing the sensitivity level for a particular region in response to determining that the portion of damage-index data for the particular region indicates higher than normal likelihood of occurrence of a damage-causing event.

In some examples, obtaining the damage-index data may include performing one or more of, for example, i) receiving prior-knowledge data (which may include one or more of, for instance, historical wind speed information in the geographical area, historical flood information, historical storm path information for the geographical area, historical flood map information for the geographical area, burn-index information, vegetation index, and/or weather reports for the geographical area), ii) applying a damage detection model, implemented on a learning machine, to the received image data for the geographical area to generate segmented data representative of one or more segmented regions in the received image data associated with respective one or more types of damage-causing events, and/or iii) receiving multi-band geospatial data, and filtering the multi-band geospatial data to extract band data, for the geographical area, to generate one or more multi-band indices. In such examples, detecting damage to the object may include generating a composite damage index map based on one or more of, for example, the prior-knowledge data, the generated segmented data, and/or the one or more multi-band indices.

In some embodiments, detecting damage to the object, from the one or more objects in the geographical area, may include detecting the one or more objects in the geographical area (e.g., using filtering-based techniques to detect or identify objects, or learning engines implementing object detection models) based on one or more of, for example, currently received image data obtained subsequent to occurrence of a damage-causing event affecting the geographical area, and/or earlier received image data obtained prior to the occurrence of the damage-causing event affecting the geographical area with the earlier received image data being aligned to the currently received image data. Such data aligning may be performed, for example, based on geo-reference data that may be associated with current and earlier baseline data, by aligning contours or geometrical shapes identified in pairs images so that detected objects substantially overlap, etc. In some situations, the identification of objects may be determined using both earlier and later image (e.g., detecting the objects from the earlier image, and confirming/corroborating the identification of the objects based on the currently received image). In some situations, only the earlier image is used to detect the objects in the geographical area, while the currently received image is used to determine the damage inflicted to the objects identified from the earlier image. In some situations, detecting the objects in the geographical area and determining the damages to such objects may be derived only from the currently received image data.

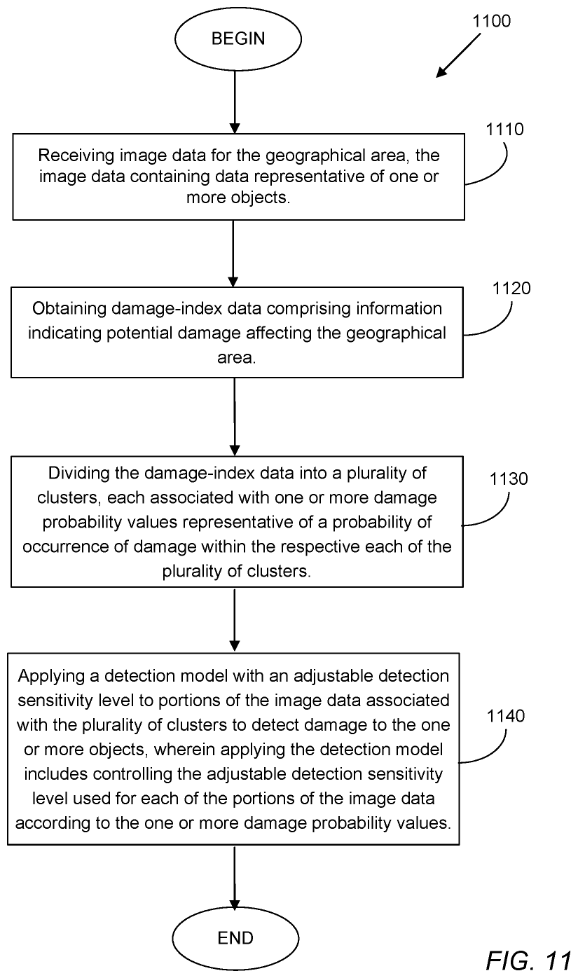

With reference to FIG. 11, a flowchart of an example procedure 1100 to detect damage using adjustable sensitivity levels to control a detection model is shown. The procedure 1100 includes receiving 1110 image data for the geographical area, with the image data containing data representative of one or more objects. In some examples, the image data may include multi-band geospatial data (e.g., obtained via the platforms 120 or 122 of FIG. 1). The procedure 1100 further includes obtaining 1120 damage-index data comprising information indicating potential damage affecting the geographical area. The damage-index data may include one or more of, for example, historical wind speed information in the geographical area, historical flood information, historical storm path information for the geographical area, historical flood map information for the geographical area, burn-index information, vegetation index, and/or weather reports for the geographical area. In examples in which the image data is multi-band geospatial data, obtaining the damage-index data may include filtering the multi-band geospatial data to extract band data, for the geographical area, to identify one or more types of damage affecting the geographical area, and deriving based on the extracted band data one or more resultant damage index images identifying portions within each of the one or more resultant damage index images that potentially are affected by the respective one or more types of damage.

The procedure 1100 further includes dividing 1130 the damage-index data into a plurality of clusters, each associated with one or more damage probability values representative of a probability of occurrence of damage within the respective each of the plurality of clusters. For example, dividing the damage-index data into the plurality of clusters may include performing a k-mean clustering process on the damage-index data to determine clusters comprising data elements satisfying an optimization criterion.

The procedure 1100 also includes applying 1140 a detection model with an adjustable detection sensitivity level to portions of the image data associated with the plurality of clusters to detect damage to the one or more objects. Applying the detection model includes controlling the adjustable detection sensitivity level used for each of the portions of the image data according to the one or more damage probability values. In some examples, the adjustable detection sensitivity level is controlled according to a receiver operation curve (ROC) representation. In such examples, applying the damage detection model may include dynamically tuning an operation point for the ROC for a particular portion of the image data based on likelihood of occurrence of damage, determined based on the damage-index data, in a region within the geographical area, to adjust a sensitivity level of the ROC, or to adjust a false-positive detection rate. Dynamically tuning the operation point for the ROC may include one of, for example, decreasing the detection sensitivity value for the detection model to cause a decrease in the false-positive detection rate within the region, or increasing the detection sensitivity for the detection model to cause an increase in the false-positive detection rate within the region.

In some embodiments, applying the detection model may include adjusting detection sensitivity levels for a first region and for a second region in the geographical area so that a likelihood of identifying a first object in the first region as being damaged is higher than a likelihood of identifying a second object in the second region as being damaged, when the damage-index data indicates that a likelihood of occurrence of damage-causing event in the first region is higher than a likelihood of occurrence of the damage-causing event in the second region. Controlling the adjustable detection sensitivity level may include increasing the sensitivity level for a particular region in response to determining that the portion of damage-index data for the particular region indicates higher than normal likelihood of occurrence of a damage-causing event. In some examples, applying the detection model may include applying a detection model implemented as a binary classifier.

Unless defined otherwise, all technical and scientific terms used herein have the same meaning as commonly or conventionally understood. As used herein, the articles “a” and “an” refer to one or to more than one (i.e., to at least one) of the grammatical object of the article. By way of example, “an element” means one element or more than one element. “About” and/or “approximately” as used herein when referring to a measurable value such as an amount, a temporal duration, and the like, encompasses variations of ±20% or ±10%, ±5%, or +0.1% from the specified value, as such variations are appropriate in the context of the systems, devices, circuits, methods, and other implementations described herein. “Substantially” as used herein when referring to a measurable value such as an amount, a temporal duration, a physical attribute (such as frequency), and the like, also encompasses variations of ±20% or ±10%, ±5%, or +0.1% from the specified value, as such variations are appropriate in the context of the systems, devices, circuits, methods, and other implementations described herein.

As used herein, including in the claims, “or” as used in a list of items prefaced by “at least one of” or “one or more of” indicates a disjunctive list such that, for example, a list of “at least one of A, B, or C” means A or B or C or AB or AC or BC or ABC (i.e., A and B and C), or combinations with more than one feature (e.g., AA, AAB, ABBC, etc.). Also, as used herein, unless otherwise stated, a statement that a function or operation is “based on” an item or condition means that the function or operation is based on the stated item or condition and may be based on one or more items and/or conditions in addition to the stated item or condition.

Although particular embodiments have been disclosed herein in detail, this has been done by way of example for purposes of illustration only, and is not intended to be limiting with respect to the scope of the appended claims, which follow. Features of the disclosed embodiments can be combined, rearranged, etc., within the scope of the invention to produce more embodiments. Some other aspects, advantages, and modifications are considered to be within the scope of the claims provided below. The claims presented are representative of at least some of the embodiments and features disclosed herein. Other unclaimed embodiments and features are also contemplated.

1. A method for detecting damage in a geographical area, the method comprising:
receiving image data for the geographical area, the image data containing data representative of one or more objects;
obtaining damage-index data comprising information indicating potential damage affecting the geographical area; and
detecting damage to an object, from the one or more objects in the geographical area, based on the received image data for the geographical area and the damage-index data comprising the information indicating the potential damage affecting the geographical area.

2. The method of claim 1, wherein detecting damage to the object based on the received image data for the geographical area and the damage-index data comprises:
generating one or more damage index images from the obtained damage index data; and
detecting damage to the object based on the received image data and the one or more damage index images.

3. The method of claim 2, wherein the image data for the geographical area comprises multi-band geospatial data, and wherein obtaining the damage-index data includes filtering the image data comprising the multi-band geospatial data to extract band data, for the geographical area, to identify one or more types of damage;
and wherein generating the one or more damage-index images comprises generating, based on the extracted band data, the one or more damage index images identifying portions within each of the one or more damage-index images that potentially are affected by the respective one or more types of damage.

4. The method of claim 3, wherein filtering the image data comprising the multi-band geospatial data comprises:
filtering the image data to extract one or more of RGB band data for the image, false color composite data comprising near infrared data for the image plus red component and green component data for the image, or RGB band data for the image plus infrared band data for the image.

5.-7. (canceled)

8. The method of claim 2, wherein generating the one or more damage index images comprises:
applying a damage detection model, implemented on a learning machine, to the received image data for the geographical area to detect regions in the received image data associated with respective one or more types of damage-causing events.

9. The method of claim 2, wherein detecting damage to the object based on the one or more damage index images comprises:
detecting at least some of the one or more objects in the received image data; and
determining overlap between the detected at least some of the one or more objects in the received image data and regions of the one or more generated damage-index images comprising data representative of respective types of damage.

10. The method of claim 1, wherein detecting damage to the object comprises:
dividing the image data into multiple portions according to the damage index data; and
for each of the multiple portions of the divided image data, applying a damage detection model with an adjustable detection sensitivity level, including controlling the adjustable detection sensitivity level based on a portion of the damage-index data corresponding to the respective portions of the divided image data.

11. The method of claim 10, wherein the adjustable sensitivity level is controlled according to a receiver operation curve (ROC) representation, and wherein applying the damage detection model comprises:
dynamically tuning an operation point for the ROC for a particular portion of the image data based on likelihood of occurrence of damage, determined based on the damage-index data, in a region within the geographical area to adjust a false-positive detection rate of the detection model, or adjust a detection sensitivity value for the detection model within the region.

12. The method of claim 11, wherein dynamically tuning the operation point for the ROC comprises one of:
decreasing the detection sensitivity value for the detection model to cause a decrease in the false-positive detection rate within the region; or
increasing the detection sensitivity for the detection model to cause an increase in the false-positive detection rate within the region.

13. The method of claim 10, wherein applying the detection model comprises:
adjusting the detection sensitivity levels for a first region and for a second region in the geographical area so that a likelihood of identifying a first object in the first region as being damaged is higher than a likelihood of identifying a second object in the second region as being damaged, when the damage-index data indicates that a likelihood of occurrence of damage in the first region is higher than a likelihood of occurrence of the damage in the second region.

14. The method of claim 10, wherein applying the detection model includes applying a detection model implemented as a binary classifier.

15. The method of claim 14, wherein controlling the adjustable detection sensitivity level comprises adjusting a discrimination threshold of the binary classifier.

16. The method of claim 10, wherein controlling the adjustable detection sensitivity level comprises:
increasing the sensitivity level for a particular region in response to determining that the portion of damage-index data for the particular region indicates higher than normal likelihood of occurrence of a damage-causing event.

17. The method of claim 10, wherein the image data of the geographical area comprises multi-band geospatial data, and wherein obtaining the damage-index data comprises:
filtering the image data comprising the multi-band geospatial data to extract band data, for the geographical area, to identify one or more types of damage; and
generating based on the extracted band data one or more resultant damage index images identifying portions within each of the one or more resultant damage index images that potentially are affected by the respective one or more types of damage.

18. The method of claim 10, wherein obtaining the damage-index data comprises:
applying a damage detection model, implemented on a learning machine, to the received image data for the geographical area to detect regions in the received image data associated with respective one or more types of damage; and
generating, based on the detected regions in the received image data associated with the respective one or more types of damage-causing events, one or more resultant damage index images identifying portions within each of the one or more resultant damage index images that potentially are affected by the respective one or more types of damage.

19. The method of claim 1, wherein obtaining the damage-index data comprises performing one or more of:
i) receiving prior-knowledge data including one or more of historical wind speed information in the geographical area, historical flood information, historical storm path information for the geographical area, historical flood map information for the geographical area, burn-index information, vegetation index, or weather reports for the geographical area;
ii) applying a damage detection model, implemented on a learning machine, to the received image data for the geographical area to generate segmented data representative of one or more segmented regions in the received image data associated with respective one or more types of damage-causing events; or
iii) receiving multi-band geospatial data, and filtering the multi-band geospatial data to extract band data, for the geographical area, to generate one or more multi-band indices; and
and wherein detecting damage to the object comprises generating a composite damage index map based on one or more of: the prior-knowledge data, the generated segmented data, or the one or more multi-band indices.

20. The method of claim 1, wherein detecting damage to the object, from the one or more objects in the geographical area, comprises:
detecting the one or more objects in the geographical area based on one or more of: currently received image data obtained subsequent to occurrence of a damage-causing event affecting the geographical area, or earlier received image data obtained prior to the occurrence of the damage-causing event affecting the geographical area with the earlier received image data being aligned to the currently received image data.

21. A system comprising:
a communication interface to receive image data for a geographical area, the image data containing data representative of one or more objects; and
a controller coupled to the communication interface, and configured to:
obtain damage index-data comprising information indicating potential damage affecting the geographical area; and
detect damage to an object, from the one or more objects in the geographical area, based on the received image data for the geographical area and the damage-index data comprising the information indicating the potential damage affecting the geographical area.

22.-32. (canceled)

33. A method for detecting damage in a geographical area, the method comprising:
receiving image data for the geographical area, the image data containing data representative of one or more objects;
obtaining damage-index data comprising information indicating potential damage affecting the geographical area;
dividing the damage-index data into a plurality of clusters, each associated with one or more damage probability values representative of a probability of occurrence of damage within the respective each of the plurality of clusters; and
applying a detection model with an adjustable detection sensitivity level to portions of the image data associated with the plurality of clusters to detect damage to the one or more objects, wherein applying the detection model includes controlling the adjustable detection sensitivity level used for each of the portions of the image data according to the one or more damage probability values.

34. (canceled)

35. (canceled)

36. The method of claim 33, wherein the adjustable detection sensitivity level is controlled according to a receiver operation curve (ROC) representation, and wherein applying the damage detection model comprises:
dynamically tuning an operation point for the ROC for a particular portion of the image data based on likelihood of occurrence of damage, determined based on the damage-index data, in a region within the geographical area, to adjust a false-positive detection rate.

37.-41. (canceled)

42.-48. (canceled)
